(19) United States
(12) Patent Application Publication
(10) Pub. No.: US 2012/0240572 A1
(43) Pub. Date: Sep. 27, 2012

(54) INTERNAL COMBUSTION ENGINE EQUIPPED WITH WASTEGATE TURBINES, AND METHOD FOR OPERATING AN INTERNAL COMBUSTION ENGINE OF SAID TYPE

(75) Inventors: Norbert Andreas Schorn, Aachen (DE); Rainer Friedfeldt, Huerth (DE); Guenter Bartsch, Gummersbach (DE); Kai Sebastian Kuhlbach, Bergisch Gladbach (DE)

(73) Assignee: FORD GLOBAL TECHNOLOGIES, LLC, Dearborn, MI (US)

(21) Appl. No.: 13/418,964

(22) Filed: Mar. 13, 2012

(30) Foreign Application Priority Data
Mar. 25, 2011 (EP) 11159784.5

(51) Int. Cl. F02B 37/18; F02B 37/007; F02B 37/12

(52) U.S. Cl. 60/602; 60/612

(57) ABSTRACT

Embodiments for a turbocharged engine including two turbochargers are provided. In one example, a turbocharger engine includes two turbochargers arranged in parallel, each coupled to a separate exhaust manifold. Bypass of exhaust around both turbochargers may be provided via a single wastegate.

### RELATED APPLICATIONS

The present application claims priority to European Patent Application No. 11159784.5, filed on Mar. 25, 2011, the entire contents of which are hereby incorporated by reference for all purposes.

### FIELD

The disclosure relates to a supercharged internal combustion engine having at least two exhaust-gas turbochargers.

### BACKGROUND AND SUMMARY

Internal combustion engines have a cylinder block and at least one cylinder head which are connected to one another to form the cylinders. To control the charge exchange, an internal combustion engine requires control elements—generally in the form of valves—and actuating devices for actuating said control elements. The valve actuating mechanism required for the movement of the valves, including the valves themselves, is referred to as the valve drive. The cylinder head often serves to accommodate the valve drive.

During the charge exchange, the combustion gases are discharged via the outlet openings of the cylinders, and the charging of the combustion chambers, that is to say the induction of fresh mixture or fresh air, takes place via the inlet openings. It is the object of the valve drive to open and close the inlet and outlet openings at the correct times, with a fast opening of the largest possible flow cross sections being sought in order to keep the throttling losses in the inflowing and outflowing gas flows low and in order to ensure the best possible charging of the combustion chamber with fresh mixture, and an effective, that is to say complete, discharge of the exhaust gases. Therefore, the cylinders are also often provided with two or more inlet and outlet openings. The at least two cylinders of the internal combustion engine to which the present disclosure relates are also provided with at least two outlet openings.

The inlet ducts which lead to the inlet openings, and the outlet ducts, that is to say exhaust lines, which adjoin the outlet openings, are at least partially integrated in the cylinder head. The exhaust lines of the cylinders generally merge to form one common overall exhaust line, or else in groups to form two or more overall exhaust lines. The merging of exhaust lines to form an overall exhaust line is referred to in general and within the context of the present disclosure as an exhaust manifold, with that part of the overall exhaust line which lies upstream of a turbine arranged in the overall exhaust line being considered according to the disclosure as belonging to the exhaust manifold.

Downstream of the manifold, the exhaust gases are in the present case supplied, for the purpose of supercharging of the internal combustion engine, to the turbines of at least two exhaust-gas turbochargers and if appropriate to one or more systems for exhaust-gas aftertreatment.

An exhaust-gas turbocharger comprises a compressor and a turbine which are arranged on the same shaft, with the hot exhaust-gas flow being supplied to the turbine and expanding in said turbine with a release of energy, as a result of which the shaft is set in rotation. Owing to the high rotational speed, the shaft is preferably held by plain bearings. The energy supplied by the exhaust-gas flow to the turbine and ultimately to the shaft is used for driving the compressor which is likewise arranged on the shaft. The compressor delivers and compresses the charge air supplied to it, as a result of which supercharging of the cylinders is obtained. If appropriate, a charge-air cooling arrangement is provided by means of which the compressed combustion air is cooled before it enters the cylinders.

Supercharging serves primarily to increase the power of the internal combustion engine. Here, the air required for the combustion process is compressed, as a result of which a greater air mass can be supplied to each cylinder per working cycle. In this way, the fuel mass and therefore the mean effective pressure can be increased. Supercharging is a suitable means for increasing the power of an internal combustion engine while maintaining an unchanged swept volume, or for reducing the swept volume while maintaining the same power. In any case, supercharging leads to an increase in volumetric power output and an improved power-to-weight ratio. For the same vehicle boundary conditions, it is thus possible to shift the load collective toward higher loads, where the specific fuel consumption is lower.

The configuration of the exhaust-gas turbocharging often poses difficulties, wherein it is sought to obtain a noticeable performance increase in all rotational speed ranges. A severe torque drop is however observed in the event of a certain rotational speed being undershot. Said torque drop is understandable if one takes into consideration that the charge pressure ratio is dependent on the turbine pressure ratio. In the case of a diesel engine, for example, if the engine rotational speed is reduced, this leads to a smaller exhaust-gas mass flow and therefore to a lower turbine pressure ratio. This has the result that, toward lower rotational speeds, the charge pressure ratio likewise decreases, which equates to a torque drop.

Here, it would fundamentally be possible for the drop in charge pressure to be counteracted by means of a reduction in the size of the turbine cross section, and the associated increase in the turbine pressure ratio. This however merely shifts the torque drop further in the direction of lower rotational speeds. Furthermore, said approach, that is to say the reduction in size of the turbine cross section, is subject to limits because the desired supercharging and performance increase should be possible without restriction even at high rotational speeds, that is to say in the case of high exhaust-gas quantities.

It is sought to improve the torque characteristic of a supercharged internal combustion engine using various measures. One such measure, for example, is a small design of the turbine cross section and simultaneous provision of an exhaust-gas blow-off facility. Such a turbine is also referred to as a wastegate turbine. If the exhaust-gas mass flow exceeds a critical value, then by opening a shut-off element, a part of the exhaust-gas flow is, within the course of the so-called exhaust-gas blow-off, conducted via a bypass line past the turbine or the turbine impeller. This approach has the disadvantage that the supercharging behavior is inadequate at relatively high rotational speeds or in the case of relatively high exhaust-gas quantities.

The torque characteristic of a supercharged internal combustion engine may furthermore be improved by means of multiple turbochargers arranged in parallel, that is to say a plurality of turbines of small cross section arranged in parallel, wherein turbines are activated with increasing exhaust-gas quantity.

The inventors herein have recognized the issues with the above approaches and herein provide a system to at least partly address them. In one example embodiment, a supercharged internal combustion engine comprises at least one cylinder head with at least two cylinders, each cylinder having at least two outlet openings for discharging exhaust gases, at least one outlet opening being an activatable outlet opening, each outlet opening being adjoined by an exhaust line; a first exhaust manifold wherein the exhaust lines of the activatable outlet openings of at least two cylinders merge to form a first overall exhaust line which is connected to a first turbine of a first exhaust-gas turbocharger, the first turbine equipped with a first bypass line which branches off from the first exhaust manifold upstream of the first turbine; and a second exhaust manifold wherein the exhaust lines of the other outlet openings of the at least two cylinders merge to form a second overall exhaust line which is connected to a second turbine of a second exhaust-gas turbocharger, the second turbine equipped with a second bypass line which branches off from the second exhaust manifold upstream of the second turbine, wherein the first bypass line and the second bypass line merge, with the formation of a junction point, to form a common bypass line, and, at the junction point, a shut-off element is provided which can be adjusted between an open position and a closed position, the shut-off element separating the first and second bypass lines from the common bypass line when in the closed position and connecting the first and second bypass lines to the common bypass line when in the open position.

Thus, a supercharged internal combustion engine as disclosed includes at least two exhaust-gas turbochargers arranged in parallel, wherein one turbine is designed as an activatable turbine which is acted on with exhaust gas, that is to say activated, only in the case of relatively high exhaust-gas quantities.

Here, it is sought to arrange the turbines as close as possible to the outlet, that is to say the outlet openings of the cylinder in order thereby firstly to be able to make optimum use of the exhaust-gas enthalpy of the hot exhaust gases, which is determined significantly by the exhaust-gas pressure and the exhaust-gas temperature, and secondly to ensure a fast response behavior of the turbochargers. In this connection, it is therefore fundamentally sought to minimize the thermal inertia and the volume of the line system between the outlet openings on the cylinders and the turbines, which may be achieved by reducing the mass and the length of the exhaust lines.

To achieve the above-stated aims, the exhaust lines of at least two cylinders are merged in a grouped manner in such a way that, from each of said cylinders, at least one exhaust line leads to the turbine of the first exhaust-gas turbocharger and at least one exhaust line leads to the turbine of the second exhaust-gas turbocharger.

According to the disclosure, the turbine of the first exhaust-gas turbocharger, that is to say the first turbine, is designed as an activatable turbine, and the outlet openings of the exhaust lines leading to said turbine are—correspondingly—designed as activatable outlet openings. Only in the case of relatively high exhaust-gas quantities are the activatable outlet openings opened, and the first turbine thereby activated, that is to say acted on with exhaust gas, during the course of the charge exchange.

In comparison with embodiments in which a single coherent line system is provided upstream of the two turbines, the above-described grouping, that is to say the use of two mutually separate exhaust manifolds, improves the operating behavior of the internal combustion engine, in particular at low exhaust-gas flow rates, inter alia because the line volume upstream of the second turbine, through which exhaust gas flows continuously, is reduced in size by this measure, which is advantageous, in particular improves response behavior, at low loads and rotational speeds, that is to say in the case of low exhaust-gas quantities.

In the internal combustion engine according to the disclosure, both turbines are formed as wastegate turbines. For this purpose, the first turbine is equipped with a first bypass line which branches off from the first exhaust manifold upstream of the first turbine, and the second turbine is equipped with a second bypass line which branches off from the second exhaust manifold upstream of the second turbine.

According to previous systems, for the blow-off of exhaust gas via the bypass line, a shut-off element is provided in each bypass line of the two turbines. The shut-off elements are thermally highly loaded as a result of their being acted on with hot exhaust gas, such that said shut-off elements may be manufactured from suitable materials. This fact makes the shut-off elements expensive components.

In connection with the shut-off element of a wastegate turbine, it may furthermore be taken into consideration that the control of the shut-off element is relatively complex and, when using a pressure cell for charge-pressure or exhaust-gas-pressure control, there is a corresponding spatial requirement for the pressure cell and the associated mechanism. The latter in particular opposes a compact design and dense packaging.

In the internal combustion engine according to the disclosure, only a single shut-off element is required to control the exhaust-gas blow-off at both turbines. For this purpose, the two bypass lines of the turbines merge, with the formation of a junction point, to form a common bypass line, wherein the shut-off element for exhaust-gas blow-off is arranged at the junction point. Said measure allows both bypass lines to be opened and closed by means of only one shut-off element. Thus, a supercharged internal combustion engine which has a lower number of thermally highly loaded shut-off elements may be provided

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 schematically shows a first embodiment of the internal combustion engine.

FIG. 2 is a flow chart illustrating a method according to an embodiment of the present disclosure.

### DETAILED DESCRIPTION

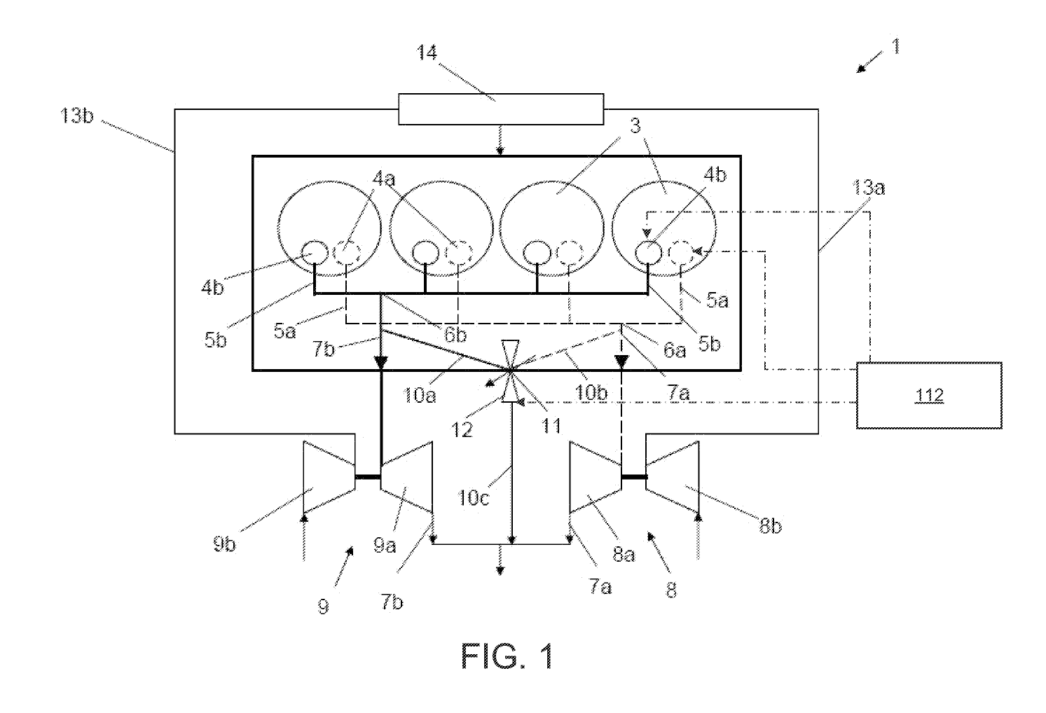

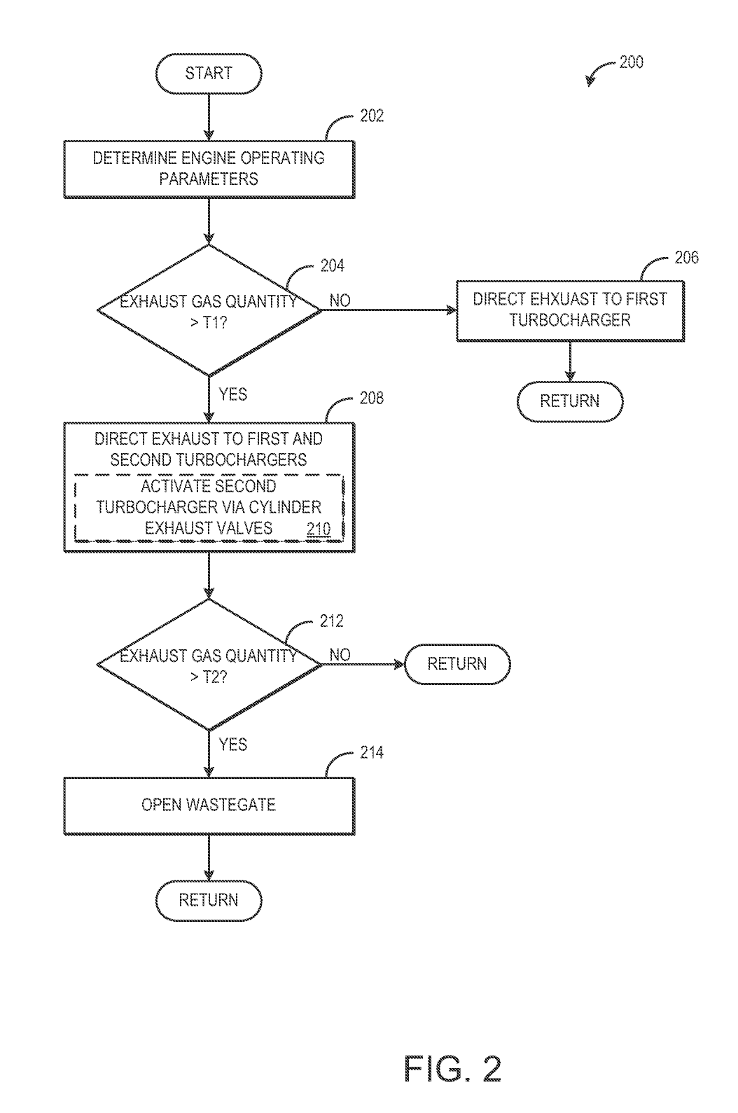

Embodiments for directing exhaust gas through multiple exhaust manifolds each coupled to a turbocharger are provided. FIG. 1 is an engine diagram illustrating an example embodiment of an internal combustion engine according to the present disclosure. FIG. 2 is a flow chart illustrating an example method which may be carried by the engine of the present disclosure.

Within the context of the present disclosure, the expression “internal combustion engine” encompasses in particular spark-ignition engines, but also diesel engines and hybrid internal combustion engines.

FIG. 1 schematically shows a first embodiment of the internal combustion engine 1 which is equipped with two exhaust-gas turbochargers 8, 9. Each exhaust-gas turbocharger 8, 9 comprises a turbine 8a, 9a and a compressor 8b, 9b arranged on the same shaft. The hot exhaust gas expands in the turbines 8a, 9a with a release of energy and the compressors 8b, 9b compress the charge air which is supplied to the cylinders 3 via intake lines 13a, 13b and plenum 14, as a result of which the supercharging of the internal combustion engine 1 is realized.

The internal combustion engine 1 is a four-cylinder in-line engine in which the cylinders 3 are arranged along the longitudinal axis of the cylinder head 2, that is to say in a line. Each cylinder 3 has two outlet openings (or exhaust ports) 4a, 4b, wherein each outlet opening 4a, 4b is adjoined by an exhaust line 5a, 5b for discharging the exhaust gases out of the cylinder 3.

In each case one outlet opening 4a of each cylinder 3 is designed as a switchable outlet opening 4a which is opened during the course of the charge exchange only if the exhaust-gas quantity exceeds a first predefined exhaust-gas quantity. In this way, the first turbine 8a arranged downstream is activated, that is to say acted on with exhaust gas. The exhaust lines 5a of the activatable outlet openings 4a of all the cylinders 3 merge, with the formation of a first exhaust manifold 6a, to form a first overall exhaust line 7a which is connected to the turbine 8a of the first exhaust-gas turbocharger 8 (dashed lines).

The exhaust lines 5b of the other outlet openings 4b of all the cylinders 3 merge, with the formation of a second exhaust manifold 6b, to form a second overall exhaust line 7b which is connected to the turbine 9a of the second exhaust-gas turbocharger 9 (solid lines).

In the present case, the exhaust lines 5a, 5b merge to form overall exhaust lines 7a, 7b within the cylinder head 2.

As can be seen from FIG. 1, both turbines 8a, 9a are formed as wastegate turbines 8a, 9a, in which exhaust gas can be blown off via bypass lines 10a, 10b, 10c. In the present case, the first turbine 8a is equipped with a first bypass line 10a which branches off from the overall exhaust line 7a of the first exhaust manifold 6a upstream of the first turbine 8a, and the second turbine 9a is equipped with a second bypass line 10b which branches off from the overall exhaust line 7b of the second exhaust manifold 6b upstream of the second turbine 9a.

The first and the second bypass line 10a, 10b are integrated into the cylinder head 2, as a result of which the risk of leakage of exhaust gas is reduced, and merge, with the formation of a junction point 11, to form a common bypass line 10c.

At the junction point 11 there is provided a shut-off element 12, or wastegate, which can be adjusted between an open position and a closed position. The shut-off element 12 separates the two bypass lines 10a, 10b from the common bypass line 10c when in the closed position, and connects said bypass lines 10a, 10b to the common bypass line 10c when in the open position.

Controller 112 is shown in FIG. 1 as a conventional microcomputer including a microprocessor unit, input/output ports, read-only memory, random access memory, keep alive memory, and a conventional data bus. Controller 112 may include instructions that are executable to carry out one or more control routines. Controller 112 may receive various signals from sensors coupled to engine 1, such as input from one or more temperature sensors, pressure sensors, as well as other sensors not shown in FIG. 1. Example sensors include engine coolant temperature (ECT) from a temperature sensor, a position sensor coupled to an accelerator pedal for sensing accelerator position, a measurement of engine manifold pressure (MAP) from a pressure sensor coupled to an intake manifold of the engine, an engine position sensor from a Hall effect sensor sensing crankshaft position, a measurement of air mass entering the engine from a sensor (e.g., a hot wire air flow meter), and a measurement of throttle position. Barometric pressure may also be sensed for processing by controller 112. In a preferred aspect of the present description, an engine position sensor may produce a predetermined number of equally spaced pulses every revolution of the crankshaft from which engine speed (RPM) can be determined. Controller 112 may also output signals to various actuators of the engine, such as wastegate 12 and one or more cylinder exhaust valves that may be controlled to discharge exhaust gas via exhaust ports 4a, 4b.

An internal combustion engine according to the disclosure may also have two cylinder heads, for example if the cylinders are arranged distributed on two cylinder banks.

Examples of the internal combustion engine are advantageous in which, in the closed position of the shut-off element, there remains at least one overflow duct which connects the two bypass lines to one another. The overflow duct leads to improved operating behavior of the activatable turbine, in numerous respects.

The overflow duct allows some of the exhaust gas to flow over from the second exhaust manifold into the first exhaust manifold even in the case of relatively low exhaust-gas quantities, when the activatable turbine is generally deactivated, such that the activatable turbine is acted on with exhaust gas via the second exhaust manifold and overflow duct even in the deactivated, that is to say shut-down state.

Here, there should be supplied to the activatable turbine via the overflow duct only such an amount of exhaust gas that the turbine shaft does not fall below a minimum rotational speed n_{T}. Maintaining a certain minimum rotational speed prevents or lessens the depletion of the hydrodynamic lubricating film in the plain bearing of the shaft of the first charger. The measure of supplying a small amount of exhaust gas to the activatable turbine even in the deactivated state has an advantageous effect on the wear and the durability of the first exhaust-gas turbocharger. Furthermore, the response behavior of the activatable turbine and of the supercharging as a whole is improved, because the activatable turbine is accelerated from a higher rotational speed when activated. A torque demanded by the driver can be provided comparatively quickly, that is to say with only a small delay.

The at least one overflow duct should provide only a small exhaust-gas quantity, enough exhaust gas to ensure a minimum rotational speed n_{T} of the shaft, and should be geometrically dimensioned correspondingly. It is not the object of the activatable turbine in the deactivated state to contribute to the build-up of the charge pressure. The provision of the exhaust-gas quantity required for this purpose is the task not of the overflow duct but rather in fact—when outlet openings are open or activated—that of the first exhaust manifold.

The overflow duct, owing to its working principle, takes on significance when the activatable turbine is deactivated, that is to say in the case of low exhaust-gas quantities, when generally also the shut-off element arranged at the junction point is deactivated, that is to say closed.

In this respect, embodiments may be advantageous in which the shut-off element jointly forms the at least one overflow duct as it is moved into the closed position. If no overflow duct is provided, it has proven to be a disadvantage that the above-described internal combustion engine is equipped with two separate, mutually independent exhaust manifolds and activatable outlet openings. The activatable turbine is then completely cut off from the exhaust-gas flow, that is to say no exhaust gas whatsoever is supplied to the deactivated turbine, in the deactivated state. This results from the use of a separate exhaust manifold and the fact that the activatable outlet openings are not opened in said operating state.

As a result of the lack of exhaust-gas inflow, the rotational speed of the activatable turbine is decreased considerably in the event of deactivation. The hydrodynamic lubricating film in the shaft bearing arrangement is depleted or collapses. The response behavior of the activatable turbine in the event of activation is impaired.

For the reasons given above, examples of the internal combustion engine are advantageous in which the first exhaust manifold and the second exhaust manifold are permanently connected to one another upstream of the two turbines via at least one connecting duct which cannot be closed off. Said example is advantageous in particular if no overflow duct is provided, but also in combination with an overflow duct of the type described above.

The overflow duct and the connecting duct fulfill the same function, specifically that of supplying exhaust gas to the activatable turbine in the deactivated state in order to keep the turbine shaft above a minimum rotational speed. The overflow duct and the connecting duct will therefore hereinafter also be subsumed under the expression “duct”, that is to say referred to for short as “duct”.

With regard to the function of the two described duct types, examples of the internal combustion engine are advantageous in which the at least one overflow duct and/or the at least one connecting duct forms a throttle point which leads to a pressure reduction in the exhaust-gas flow passing through the duct.

In this way, it is ensured that only a small quantity of exhaust gas passes through the duct or the ducts, specifically precisely an amount of exhaust gas to maintain a certain minimum rotational speed of the turbine shaft.

The at least one duct should be dimensioned according to its function, that is to say should be designed to be smaller than for example the exhaust line adjoining an outlet opening, which serves to provide an adequate supply of exhaust gas to the turbine with the least possible losses.

Examples of the supercharged internal combustion engine are therefore advantageous in which the smallest cross section A_{Cross,D} of the at least one duct is smaller than the smallest cross section A_{Cross,Ex} of an exhaust line.

The flow cross section of a line or of a duct is the parameter which has significant influence on the throughput, that is to say on the quantity of exhaust gas conducted through the duct per unit of time. For comparison purposes, according to the disclosure, said flow cross section is defined as the flow cross section perpendicular to the central filament of flow.

Examples of the supercharged internal combustion engine are advantageous in which the following relationship applies: A_{Cross,D}≦0.3 A_{Cross,Ex}. Examples of the supercharged internal combustion engine are particularly advantageous in which the following relationship applies: A_{Cross,D}≦0.2 A_{Cross,Ex}, preferably A_{Cross,D}≦0.1 A_{Cross,Ex} or A_{Cross,D}≦0.05 A_{Cross,Ex}.

In internal combustion engines in which a connecting duct is provided, examples are advantageous wherein the at least one connecting duct branches off from an exhaust line of the second exhaust manifold and connects said exhaust line of the second exhaust manifold for example to an exhaust line of the first exhaust manifold or else to the overall exhaust line of the first exhaust manifold.

Since only low exhaust-gas quantities should be conducted into the first manifold via the connecting duct, the supply of exhaust gas to the connecting duct via the exhaust line of a single outlet opening is basically adequate.

If the connecting duct is acted on substantially only with the exhaust gas of a single outlet opening, pulsation may occur in the exhaust-gas flow conducted via the connecting duct. This would yield the disadvantageous effect of the activatable turbine being acted on with a pulsating exhaust-gas flow in the deactivated state.

In this respect, examples of the supercharged internal combustion engine may be advantageous in which the at least one connecting duct connects the two overall exhaust lines of the manifolds to one another. If the two overall exhaust lines are arranged adjacent to one another, said embodiment furthermore shortens the length of the connecting duct.

Examples of the supercharged internal combustion engine are advantageous in which the first bypass line branches off from the overall exhaust line of the first exhaust manifold. Since all of the exhaust gas from the outlet openings belonging to the first exhaust manifold passes through the first overall exhaust line, it is theoretically also possible in the example in question for all of the exhaust gas to be blown off via the bypass line.

That which has been stated above also applies analogously to the second bypass line. Examples of the supercharged internal combustion engine are therefore also advantageous in which the second bypass line branches off from the overall exhaust line of the second exhaust manifold.

Examples of the supercharged internal combustion engine are advantageous in which the exhaust lines of the at least two cylinders merge to form the two overall exhaust lines within the cylinder head. As has already been stated, during the course of the design configuration of the exhaust-gas turbocharging, it is sought to arrange the turbines as close as possible to the outlet of the internal combustion engine, that is to say to minimize the length and the volume of the line system upstream of the turbines. Here, an expedient measure is the substantial integration of the exhaust manifolds into the cylinder head, or the merging of the exhaust lines to form overall exhaust lines within the cylinder head.

A cylinder head of said type is characterized by a compact design, with the overall length of the exhaust lines of the exhaust manifolds, and the volume of the exhaust lines upstream of the turbines, being reduced. The use of such a cylinder head also leads to a reduced number of components, and consequently to a reduction in costs, in particular assembly and procurement costs. The compact design furthermore permits dense packing of the drive unit in the engine bay.

According to the disclosure, it is not necessary for the exhaust lines of all the cylinders of a cylinder head to merge to form two overall exhaust lines; rather, only the exhaust lines of at least two cylinders may be present to be grouped in the described way.

Examples are however particularly advantageous in which the exhaust lines of all the cylinders of the at least one cylinder head merge to form two overall exhaust lines.

If a connecting duct is provided, examples are advantageous in which the at least one connecting duct is integrated into the cylinder head. The risk of a leakage of exhaust gas is eliminated in this way. Furthermore, the realization of a compact design of the internal combustion engine is assisted. In relation to examples with an external duct, it is possible for fastening means and additional sealing elements to be dispensed with.

Examples of the internal combustion engine are also advantageous in which the first bypass line and/or the second bypass line are at least partially integrated into the cylinder head. Said example, too, reduces the number of components and therefore the costs, and reduces the risk of leakage of exhaust gas in that the branching of the bypass line takes place in the cylinder head.

Examples of the supercharged internal combustion engine are advantageous which are equipped with an at least partially variable valve drive, preferably with a fully variable valve drive, for the actuation of the outlet openings.

Examples of the supercharged internal combustion engine are advantageous in which the at least one cylinder head is equipped with an integrated coolant jacket. Supercharged internal combustion engines are thermally more highly loaded than naturally aspirated engines, as a result of which greater demands are placed on the cooling arrangement.

It is fundamentally possible for the cooling arrangement to take the form of an air-cooling arrangement or a liquid-cooling arrangement. On account of the significantly higher heat capacity of liquids in relation to air, it is possible for significantly greater heat quantities to be dissipated by means of liquid cooling than is possible with air cooling.

Liquid cooling requires the internal combustion engine, that is to say the cylinder head or the cylinder block, to be equipped with an integrated coolant jacket, that is to say the arrangement of coolant ducts which conduct the coolant through the cylinder head or cylinder block. The heat is dissipated to the coolant, generally water provided with additives, already in the interior of the component. Here, the coolant is fed by means of a pump arranged in the cooling circuit, such that said coolant circulates in the coolant jacket. The heat which is dissipated to the coolant is in this way dissipated from the interior of the head or block and extracted from the coolant again in a heat exchanger.

Thus, FIG. 1 provides for an engine system, comprising at least two cylinders arranged in-line, each cylinder having a first and second exhaust port; a first integrated exhaust manifold directing exhaust from the first exhaust port of each cylinder to a first turbocharger; a second integrated exhaust manifold directing exhaust from the second exhaust port of each cylinder to a second turbocharger; and a single wastegate to control exhaust bypass around the first and second turbochargers. The system includes a first bypass line coupling the first integrated exhaust manifold to the wastegate, and a second bypass line coupling the second integrated exhaust manifold to the wastegate.

FIG. 2 is a flow chart illustrating a method 200 in which the activatable outlet openings, which are deactivated in the case of a low exhaust-gas quantity, are activated when the exhaust-gas quantity exceeds a first predefinable exhaust-gas quantity. Method 200 may be carried out by controller 112 according to instructions stored in the memory of controller 112. At 202, method 200 includes determining engine operating parameters. Engine operating parameters may include engine speed, engine load, engine temperature, MAP, exhaust gas backpressure, etc. At 204, it is determined if an exhaust-gas quantity exceeds a first threshold.

In a non-supercharged internal combustion engine, the exhaust-gas quantity corresponds approximately to the rotational speed and/or the load of the internal combustion engine, specifically as a function of the load control used in the individual situation. In a traditional spark-ignition engine with quantity regulation, the exhaust-gas quantity increases with increasing load even at a constant rotational speed, whereas in traditional diesel engines with quality regulation, the exhaust-gas quantity is dependent merely on rotational speed, because in the event of a load shift at constant rotational speed, the mixture composition and not the mixture quantity is varied.

If the internal combustion engine according to the disclosure is based on quantity regulation, in which the load is controlled by means of the quantity of fresh mixture, the exhaust-gas quantity may exceed the first threshold even at constant rotational speed if the load of the internal combustion engine exceeds a predefinable load, because the exhaust-gas quantity correlates with load, wherein the exhaust-gas quantity increases with increasing load and falls with decreasing load.

In contrast, if the internal combustion engine is based on quality regulation, in which the load is controlled by means of the composition of the fresh mixture and the exhaust-gas quantity varies virtually exclusively with rotational speed, that is to say is proportional to the rotational speed, the exhaust-gas quantity exceeds the first threshold independently of the load if the rotational speed of the internal combustion engine exceeds a predefinable rotational speed.

The internal combustion engine according to the disclosure is a supercharged internal combustion engine, such that consideration may also be given to the charge pressure on the intake side, which may vary with the load and/or the rotational speed and which has an influence on the exhaust-gas quantity. The relationships discussed above regarding the exhaust-gas quantity and the load or rotational speed consequently apply only conditionally in this general form. The method according to the disclosure is therefore geared very generally to the exhaust-gas quantity and not to the load or rotational speed.

If it is determined that the exhaust gas quantity does not exceed the threshold, that is if the exhaust gas quantity is small enough that routing it through one turbine, as opposed to two, will not cause excessive backpressure and/or damage to the turbine, method 200 proceeds to 206 to direct the exhaust gas to the first turbocharger. In doing so, the exhaust gas is prevented from traveling through the second turbocharger. Upon directing the exhaust gas to the first turbocharger, method 200 returns.

If it is determined that the exhaust gas quantity does exceed the threshold, method 200 proceeds to 208 to direct the exhaust to both the first and second turbochargers. In this way, a portion of the exhaust will be directed to the turbine of the first turbocharger while a portion of the exhaust gas is directed to the turbine of the second turbocharger.

Directing the exhaust to the second turbocharger may include controlling one or more cylinder exhaust valves at 210. As explained with respect to FIG. 1, each cylinder may include first exhaust port with an exhaust line coupled to the first turbocharger and a second exhaust port with an exhaust line coupled to the second cylinder. During engine operation with exhaust gas quantity below the threshold, the cylinder exhaust valves of the first exhaust port of each cylinder may be opened during each exhaust stroke while the cylinder exhaust valves of the second exhaust port of each cylinder may kept closed, and as such all the exhaust in the cylinder may be released to the first turbocharger. However, when the exhaust gas quantity exceeds the threshold, the cylinder exhaust valves of the second exhaust ports may also be opened during each exhaust stroke so that a portion of the exhaust is directed to the second turbocharger in addition to the first turbocharger.

The activation of the outlet openings equates to the activation of the first turbine. A preceding acceleration of the activatable turbine via the bypass line of the second turbine designed as a wastegate turbine remains unaffected by this, that is to say is possible independently thereof.

At 212, it is determined if exhaust gas quantity exceeds a second threshold. The second threshold may be higher than the first threshold, and be a suitable threshold above which turbocharger damage may occur, or exhaust back-pressure may be high enough to reduce engine efficiency. If the exhaust gas quantity does not exceed the second threshold, method 200 returns. If the exhaust gas quantity does exceed the second threshold, method 200 proceeds to 214 to open the wastegate in order to bypass a portion of the exhaust around both the first and second turbochargers. Method 200 then returns.

If the exhaust-gas quantity falls below the first threshold again, the activatable outlet openings, and with these the activatable first turbine, may be deactivated again.

Method variants are advantageous in which the activatable outlet openings are activated when the exhaust-gas quantity exceeds first threshold and is greater than said threshold for a predefinable time period Δt₁.

The introduction of an additional condition for the activation of the first turbine is intended to prevent excessively frequent switching, in particular an activation of the activatable outlet openings, if the exhaust-gas quantity only briefly exceeds the first threshold and then falls again or fluctuates around the first threshold, without the exceedance justifying or necessitating an activation of the first turbine.

For the reasons stated above, method variants are also advantageous in which the activatable outlet openings are deactivated when the exhaust-gas quantity falls below the first threshold and is lower than said threshold for a predefinable time period Δt₂.

The fact that, according to the disclosure, both turbines are formed as wastegate turbines, and the arrangement according to the disclosure of the two associated bypass lines, permit method variants in which the first activatable turbine is accelerated shortly before the activation by virtue of the shut-off element arranged at the junction point being opened, wherein exhaust gas flows, that is to say is transferred, from the second manifold into the first manifold via the second and the first bypass line.

The common bypass line may open into one of the two overall exhaust lines, or into both overall exhaust lines, downstream of the turbines.

Examples of the method are advantageous in which the wastegate is opened when the exhaust-gas quantity exceeds a second threshold exhaust-gas quantity. Method variants are in turn advantageous in which the wastegate is opened when the exhaust-gas quantity exceeds a second threshold and is greater than said threshold exhaust-gas quantity for a predefinable time period Δt₃.

Method variants are also advantageous in which the wastegate is closed when the exhaust-gas quantity falls below the second threshold and is lower than said threshold for a predefinable time period Δt₄.

Thus, the method 200 of FIG. 2 provides for a method for an engine having a first and second turbocharger, comprising directing exhaust gas from the engine to the first turbocharger via a first integrated exhaust manifold, during a first set of conditions, directing a portion of the exhaust gas to the second turbocharger via a second integrated manifold, and during a second set of conditions, opening a wastegate to bypass exhaust around the first and second turbochargers. The method includes wherein the first set of conditions comprises exhaust gas quantity above a first threshold, and wherein the second set of conditions comprises exhaust gas quantity above a second threshold, greater than the first threshold. The method also includes opening of one or more cylinder exhaust valves during the first set of conditions in order to direct the portion of exhaust gas to the second turbocharger.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A supercharged internal combustion engine comprising:
at least one cylinder head with at least two cylinders, each cylinder having at least two outlet openings for discharging exhaust gases, at least one outlet opening being an activatable outlet opening, each outlet opening being adjoined by an exhaust line;
a first exhaust manifold wherein the exhaust lines of the activatable outlet openings of at least two cylinders merge to form a first overall exhaust line which is connected to a first turbine of a first exhaust-gas turbocharger, the first turbine equipped with a first bypass line which branches off from the first exhaust manifold upstream of the first turbine; and
a second exhaust manifold wherein the exhaust lines of the other outlet openings of the at least two cylinders merge to form a second overall exhaust line which is connected to a second turbine of a second exhaust-gas turbocharger, the second turbine equipped with a second bypass line which branches off from the second exhaust manifold upstream of the second turbine,
wherein the first bypass line and the second bypass line merge, with the formation of a junction point, to form a common bypass line, and,
at the junction point, a shut-off element is provided which can be adjusted between an open position and a closed position, the shut-off element separating the first and second bypass lines from the common bypass line when in the closed position and connecting the first and second bypass lines to the common bypass line when in the open position.

2. The supercharged internal combustion engine as claimed in claim 1, wherein, in the closed position of the shut-off element, there remains at least one overflow duct which connects the first and second bypass lines to one another.

3. The supercharged internal combustion engine as claimed in claim 2, wherein the shut-off element jointly forms the at least one overflow duct as it is moved into the closed position.

4. The supercharged internal combustion engine as claimed in claim 3, wherein the first exhaust manifold and the second exhaust manifold are permanently connected to one another upstream of the two turbines via at least one connecting duct which cannot be closed off.

5. The supercharged internal combustion engine as claimed in claim 4, wherein the at least one overflow duct and/or the at least one connecting duct forms a throttle point which causes a pressure reduction in the exhaust-gas flow passing through the duct.

6. The supercharged internal combustion engine as claimed in claim 5, wherein the at least one connecting duct is integrated into the cylinder head.

7. The supercharged internal combustion engine as claimed claim 5, wherein the smallest cross section A_{Cross,D} of the at least one duct is smaller than the smallest cross section A_{Cross,Ex} of an exhaust line.

8. The supercharged internal combustion engine as claimed in claim 7, wherein the following relationship applies: A_{Cross,D}≦0.2 A_{Cross,Ex}.

9. The supercharged internal combustion engine as claimed in claim 7, wherein the following relationship applies: A_{Cross,D}≦0.1 A_{Cross,Ex}.

10. The supercharged internal combustion engine as claimed in claim 1, wherein the first bypass line branches off from the overall exhaust line of the first exhaust manifold.

11. The supercharged internal combustion engine as claimed in claim 1, wherein the second bypass line branches off from the overall exhaust line of the second exhaust manifold.

12. The supercharged internal combustion engine as claimed in claim 1, wherein the exhaust lines of the at least two cylinders merge to form the two overall exhaust lines within the cylinder head.

13. The supercharged internal combustion engine as claimed in claim 1, wherein the first bypass line and/or the second bypass line are at least partially integrated into the cylinder head.

14. The supercharged internal combustion engine as claimed in claim 1, further comprising a controller including instructions to activate the activatable outlet openings, which are deactivated in the case of a low exhaust-gas quantity, when the exhaust-gas quantity exceeds a first predefinable exhaust-gas quantity.

15. The supercharged internal combustion engine as claimed in claim 14, wherein the shut-off element is opened when the exhaust-gas quantity exceeds a second predefinable exhaust-gas quantity.

16. An engine system, comprising:
at least two cylinders arranged in-line, each cylinder having a first and second exhaust port;
a first integrated exhaust manifold directing exhaust from the first exhaust port of each cylinder to a first turbocharger;
a second integrated exhaust manifold directing exhaust from the second exhaust port of each cylinder to a second turbocharger; and
a single wastegate to control exhaust bypass around the first and second turbochargers.

17. The engine system of claim 16, further comprising a first bypass line coupling the first integrated exhaust manifold to the wastegate, and a second bypass line coupling the second integrated exhaust manifold to the wastegate.

18. A method for an engine having a first and second turbocharger, comprising:
directing exhaust gas from the engine to the first turbocharger via a first integrated exhaust manifold;
during a first set of conditions, directing a portion of the exhaust gas to the second turbocharger via a second integrated manifold; and
during a second set of conditions, opening a wastegate to bypass exhaust around the first and second turbochargers.

19. The method of claim 18, wherein the first set of conditions comprises exhaust gas quantity above a first threshold, and wherein the second set of conditions comprises exhaust gas quantity above a second threshold, greater than the first threshold.

20. The method of claim 18, further comprising opening of one or more cylinder exhaust valves during the first set of conditions in order to direct the portion of exhaust gas to the second turbocharger.
